(19) United States
(12) Patent Application Publication
(10) Pub. No.: US 2011/0229863 A1
(43) Pub. Date: Sep. 22, 2011

(54) PHONICS CUBES

(76) Inventor: Ming Chang LEE, Taichung City (TW)

(21) Appl. No.: 12/725,103

(22) Filed: Mar. 16, 2010

(51) Int. Cl. G09B 1/00

(52) U.S. Cl. 434/172

(57) ABSTRACT

The present invention utilizes the cooperation between vowel letter surfaces on single vowel cubes and the letter surface on single consonant cubes to achieve a spelling practice of English vocabularies. By concurrently throwing or reversing one or several single vowel cubes and the single consonant cubes, the settled vowel letter surface and the letter surface facing upward further offer other phonetic practice. A serial vowel area and a serial consonant area on the single vowel cube and on the single consonant cube could help users swiftly find the letters. Serial numbers on each of the single vowel cubes and on each of the single consonant cubes are served for a speedy placement. Such teaching aid has a simple structure and low manufacturing cost. Moreover, since there are letters presented on each side of the cubes, a diverse arrangement is achieved. The present invention accomplishes a convenient utilization and diverse functions.

### FIELD OF THE INVENTION

The present invention relates to phonics cubes, in particular to phonics cubes for learners to recognize letters of the alphabet and the sounds they make and also make game out of learning to spell, to read and to practice word formation.

### DESCRIPTION OF THE RELATED ART

The conventional phonics cubes for alphabetical spelling is shown in FIGS. 14 and 15. The conventional teaching aid comprises vowel units 60, preceding consonant units 70, and subsequent consonant unit 80. Wherein, each vowel unit 60 includes a vowel cube 61 providing with a vowel phonetic area 62. Each preceding consonant unit 70 includes a preceding consonant cube 71 set in front of the vowel cube 61 of the vowel unit 60 for selectively combining therewith, and a preceding consonant phonetic area 72 disposed on the preceding consonant cube 71. Moreover, each subsequent consonant unit 80 includes a subsequent consonant cube 81 set in back of the vowel cube 61 of the vowel unit 60 for combining therewith and a subsequent consonant phonetic area 82 disposed on the subsequent consonant cube 81. Wherein, the vowel cube 61, the preceding consonant cube 71, and the subsequent consonant cube 81 have their respective elastic engaging portions 61, 71, 81 for providing a mutual engagement between the vowel unit 60, the preceding consonant unit 70, and the subsequent consonant unit 80. Thereby, learners are able to align alphabets on those units to unscramble and learn the English word. However, such teaching aid has the following shortcomings:
1. Inconvenient utilization: since the vowel cube, the preceding consonant cube, and the subsequent consonant cube are provided with respective pairs of elastic engaging portion on both sides thereof for serially connecting aforesaid cubes, the connected cubes could be merely operated by one person at a time. Namely, the connected cubes are not available for being concurrently operated by users. Therefore, the conventional teaching aid is inconvenient.
2. Limited function: The serial connection between the cubes is achieved by the elastic engaging portions disposed thereon. Whereas, available words are restricted because of such sequential connection. Moreover, the disposition of the elastic engaging portions on the two sides of each cube further decreases the number of available words.

### SUMMARY OF THE INVENTION

### Motivation of the Invention

In order to mend abovementioned shortcomings, like the inconvenient utilization and the limited function, the phonics cubes for alphabetical spelling in accordance with the present invention is herein disclosed.

### Object of the Invention

A main object of the present invention is to provide a phonics cubes for alphabetical spelling for users to arrange a first main letter surface of single vowel cubes with a second main letter surface of single consonant cubes, so as to proceed to a spelling practice of English vocabularies. Moreover, by throwing or reversing one of the single vowel cubes and one of the single consonant cubes, the settled cubes with their vowel letter surface and the letter surface facing upward are able to provide users with other phonetic practice of English vocabularies. Favorably, the disposition of a serial vowel area and a serial consonant area on the single vowel cube and the single consonant cube permits users to attain a swift search for the letters. Further, serial numbers defined on each of the single vowel cubes and the single consonant cubes are served for a speedy placement while collating. To be concise, such teaching aid has a simple structure and spends less manufacturing cost. Moreover, since there are letters presented on each side of the cubes, the using variation could be more expanded. Thus, the present invention achieves the advantages of the convenient utilization and diverse functions.

### BRIEF DESCRIPTION OF THE DRAWINGS

FIG. 1 is a schematic view showing the present invention;

FIG. 2 is a schematic view showing a single vowel cube in spreading;

FIG. 3 is a schematic view showing a single consonant cube in spreading;

FIG. 4 is a schematic view showing the single vowel cubes and the single consonant cubes in an arrangement;

FIG. 5 is a first schematic view showing the present invention in using;

FIG. 6 is a second schematic view showing the present invention in using;

FIG. 7 is a first preferred embodiment of the present invention with a compound consonant cube;

FIG. 8 is a schematic view showing the compound consonant cube in spreading;

FIG. 9 is a schematic view showing the compound consonant cubes in a serial arrangement;

FIG. 10 is a schematic view showing the single vowel cubes, the single consonant cubes, and the compound consonant cubes in a serial arrangement;

FIG. 11 is a schematic view showing a second preferred embodiment of the present invention with a compound vowel cube;

FIG. 12 is a schematic view showing the compound vowel cubes in a sequential arrangement;

FIG. 13 is a schematic view showing a third preferred embodiment of the present invention with a frame body;

FIG. 14 is a schematic view showing the conventional teaching aids; and

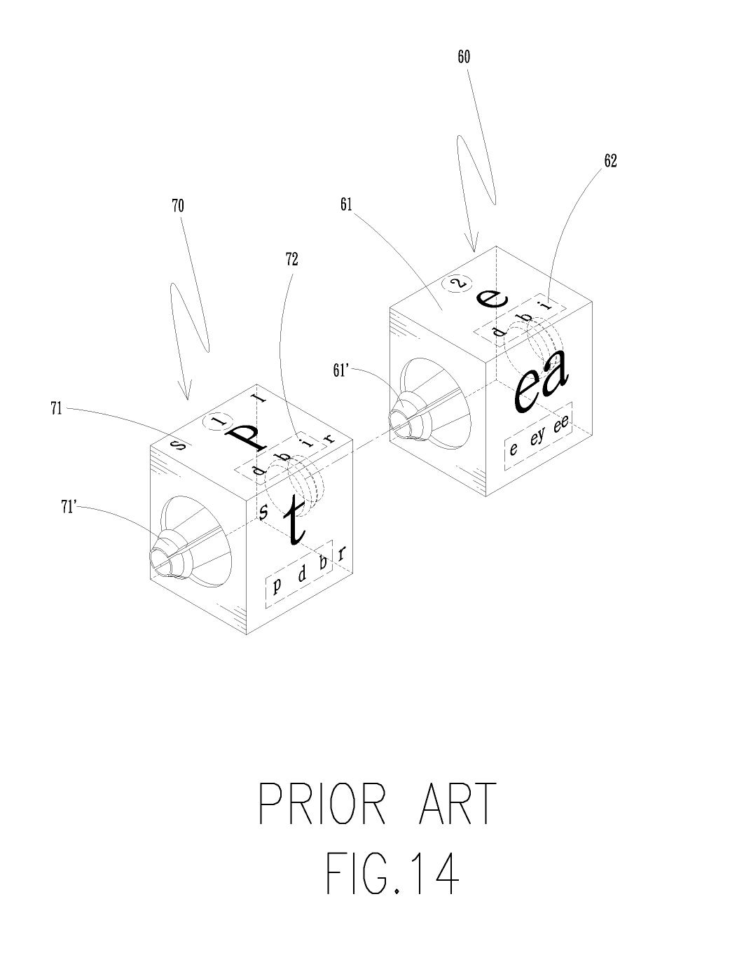

FIG. 15 is a schematic view showing the conventional teaching aids.

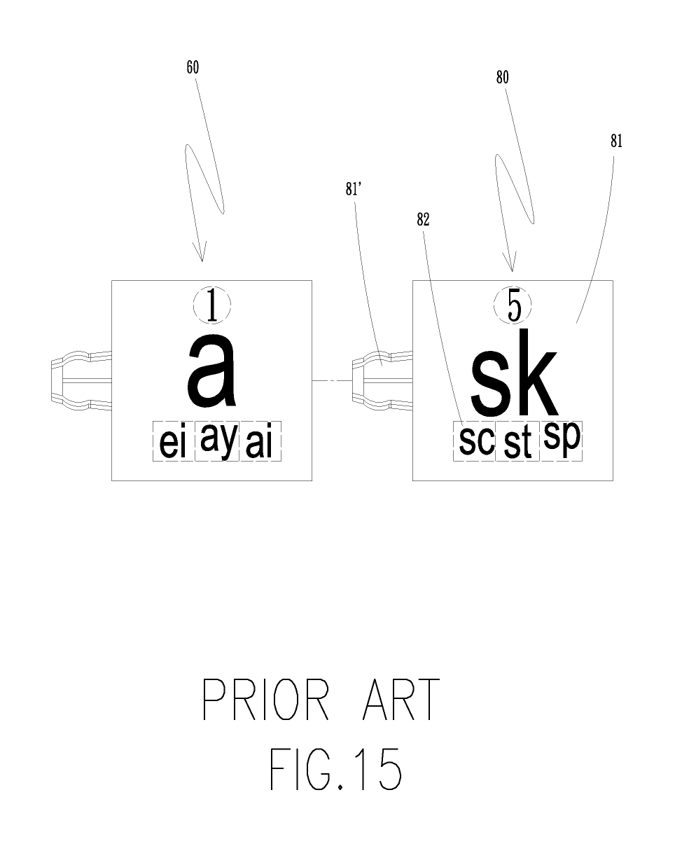

### DESCRIPTION OF ELEMENTS IN THE DRAWINGS

| | | | |
|---|---|---|---|
| 10 | single vowel cube | 11 | first main letter |
| | surface | | |
| 110 | first serial number | 111 | serial vowel area |
| 12 | vowel letter surface | 20 | single consonant cube |
| 21 | second main letter | 210 | second serial number |
| | surface | | |
| 211 | serial consonant area | 22 | letter surface |
| 30 | compound consonant | 31 | main letter string |
| | cube surface | | |
| 310 | third serial number | 311 | serial letter string |
| | area | | |
| 312 | first underline | 32 | letter string surface |
| 40 | compound vowel cube | 41 | main compound vowel |
| | surface | | |
| 410 | fourth serial number | 411 | compound vowel area |
| 412 | second underline | 42 | compound vowel |
| | surface | | |
| 50 | frame body | 51 | accommodating room |
| 60 | vowel unit | 61 | vowel cube |
| 61′ | elastic engaging | 62 | vowel phonetic area |
| | portion | | |
| 70 | preceding consonant | 71 | preceding consonant |
| | unit cube | | |
| 71′ | elastic engaging | 72 | preceding consonant |
| | portion area | | phonetic |
| 80 | subsequent consonant unit | 81 | subsequent consonant |
| | cube | | |
| 81′ | elastic engaging | 82 | subsequent consonant |
| | portion area | | phonetic |

### DETAILED DESCRIPTION OF THE PREFERRED EMBODIMENTS

The advantages of the present invention will become more apparent while following descriptions in junction with the accompanying drawings. It should be noted that the disclosed drawings served for illustration do not limit the scope of the present invention.

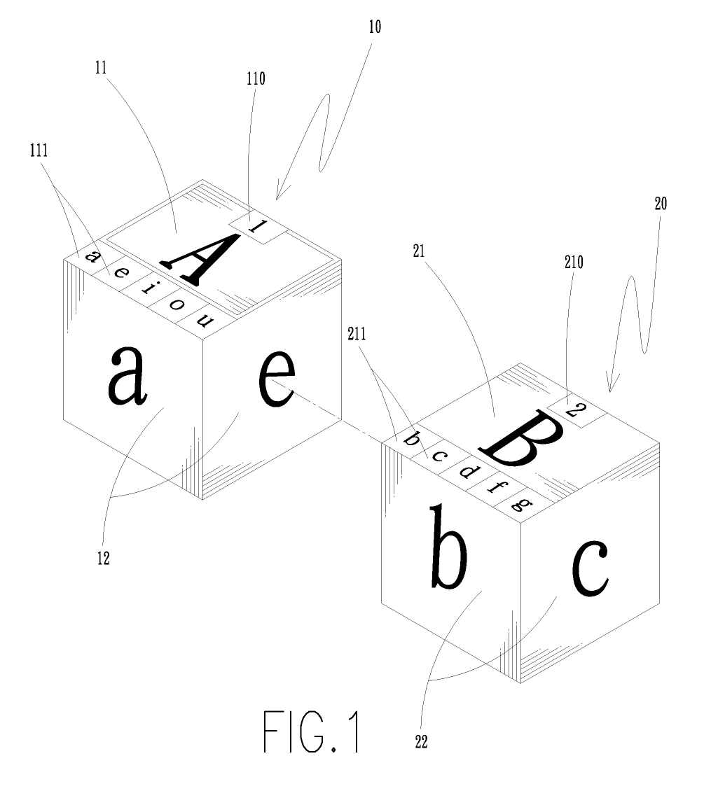

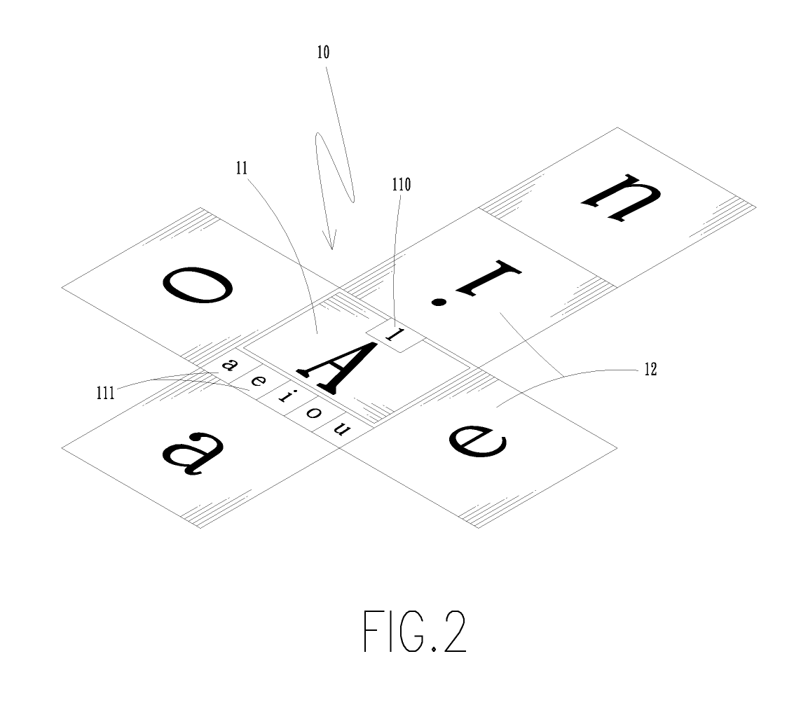

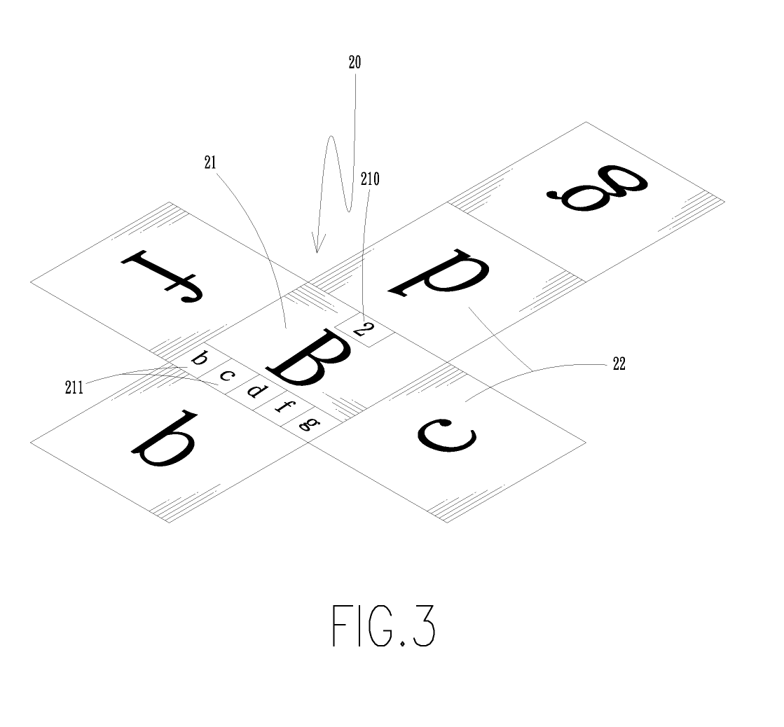

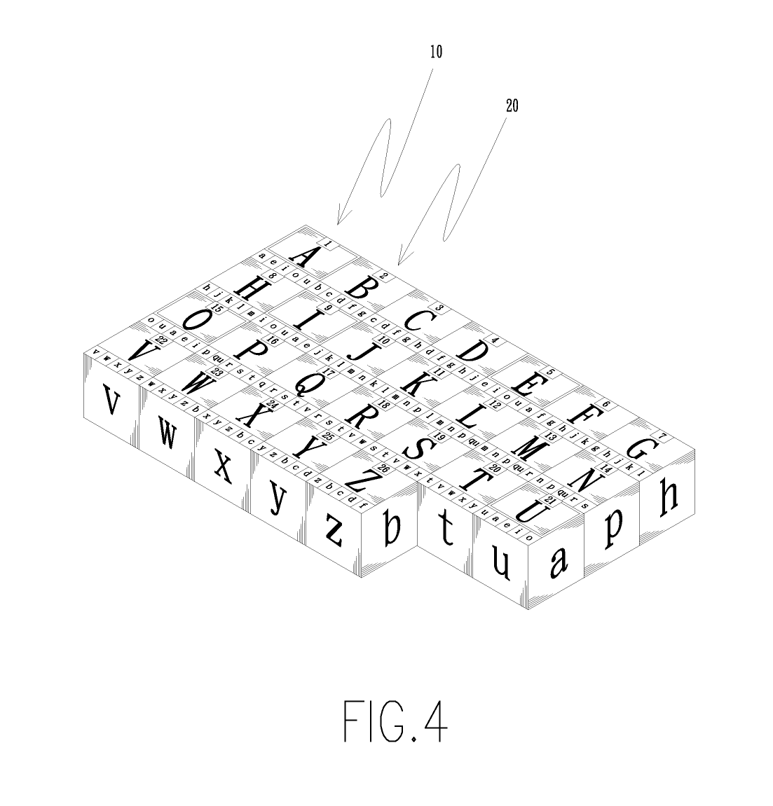

FIGS. 1 to 4 are schematic views showing the structure of the present invention, the spreading state of a single vowel cube, the spreading state of a single consonant cube, and the serial arranged single vowel cube and the single consonant cube. The present invention comprises:

a plurality of single vowel cubes 10, each of which includes a first main letter surface 11 and several vowel letter surfaces 12; the first main letter surface 11 provides with a first serial number 110 and a serial vowel area 111; wherein, the single vowel cube 10 is made of soft elastic foam or wood; and

a plurality of single consonant cubes 20, each of which includes a second main letter surface 21 and several letter surfaces 22; the second main letter surface 21 provides with a second serial number 210 and a serial consonant area 211; wherein, the second main letter surface 21 and the letter surface 22 are able to connect with both the first main letter surface 11 and the several vowel letter surfaces 12 of the single vowel cube 10; further, the single consonant cube 20 is made of soft elastic foam or wood.

By means of above elements, the teaching aid of the present invention is achieved.

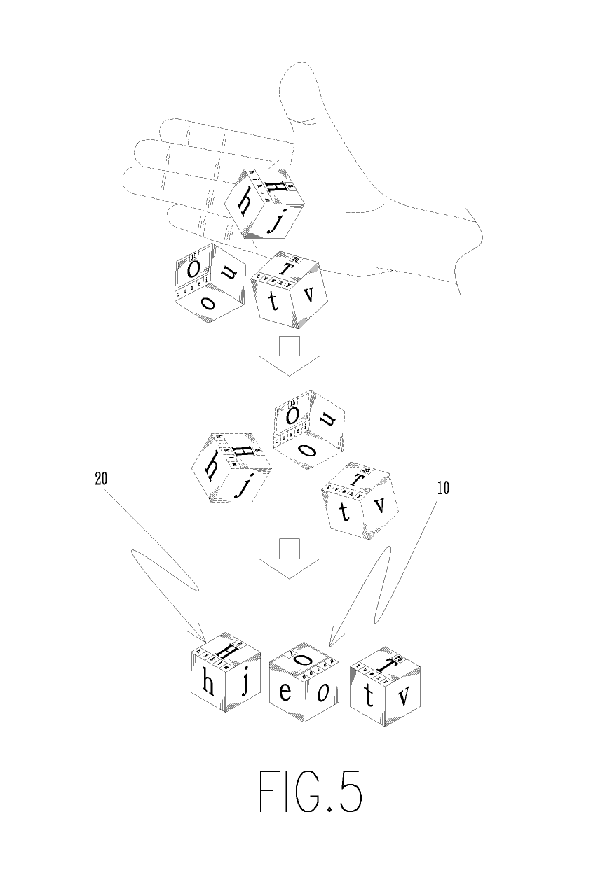

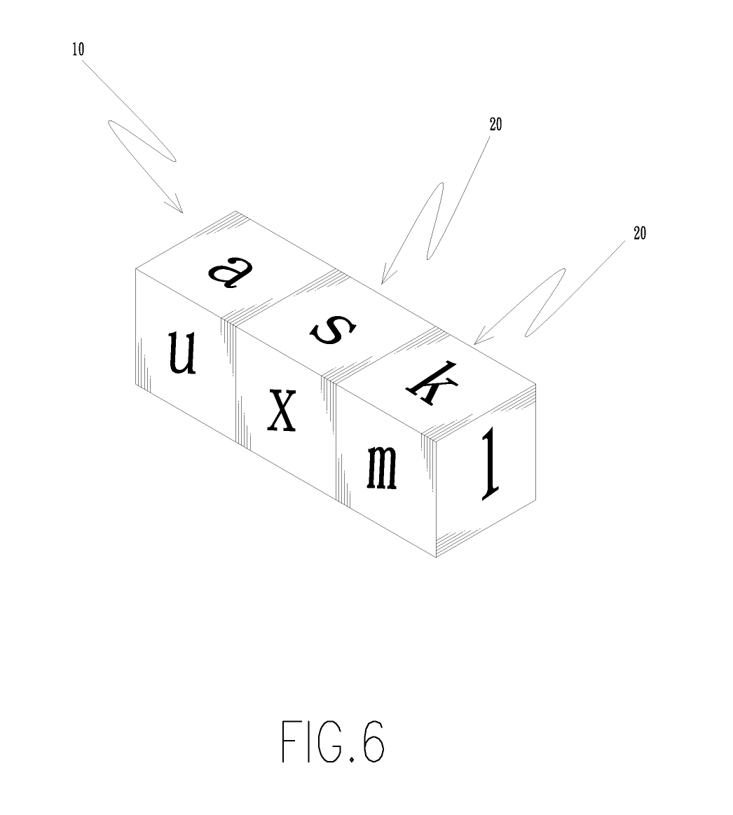

Accompanying FIGS. 5 and 6, schematic views showing the present invention in using are presented. Wherein, a plurality of single vowel cubes 10 are disclosed, each of which includes a first main letter surface 11 and several vowel letter surfaces 12. The first main letter surface 11 provides with a first serial number 110 and a serial vowel area 111. Additionally, a plurality of single consonant cubes 20 are disclosed, each of which includes a second main letter surface 21 and several letter surfaces 22. The second main letter surface 21 provides with a second serial number 210 and a serial consonant area 211. Herein, by reversing the vowel letter surfaces 12 of the single vowel cubes 10 and the letter surface 22 of the single consonant cubes 20 to promote a newly arrangement, a spelling practice of English vocabularies could be achieved. Alternatively, by concurrently throwing or reversing one or several single vowel cubes 10 and the single consonant cubes 20, the settled vowel letter surface 12 and the letter surface 22 facing upward would further provide with other phonetic practice of English vocabularies. Favorably, the disposition of a serial vowel area 111 and a serial consonant area 211 on the single vowel cube 10 and the single consonant cube 20 is capable of providing users with a swift search for the letters. In addition, the cooperation, formed by the first main letter surface 11 as well as the vowel letter surface 12 of the single vowel cube 10 and the second main letter surface 21 as well as the letter surface 22 of the single consonant cube 20, provides users with practices of capitalized letters and small letters. Moreover, serial numbers 110, 210 defined on each of the single vowel cubes 10 and on each of the single consonant cubes 20 are served for a speedy and sequential placement while not in use. To be concise, such teaching aid has a simple structure and low manufacturing cost. Moreover, since there are letters presented on each side of the cubes, the using variation could be expanded. Thus, the present invention achieves the advantages of the convenient utilization and diverse functions.

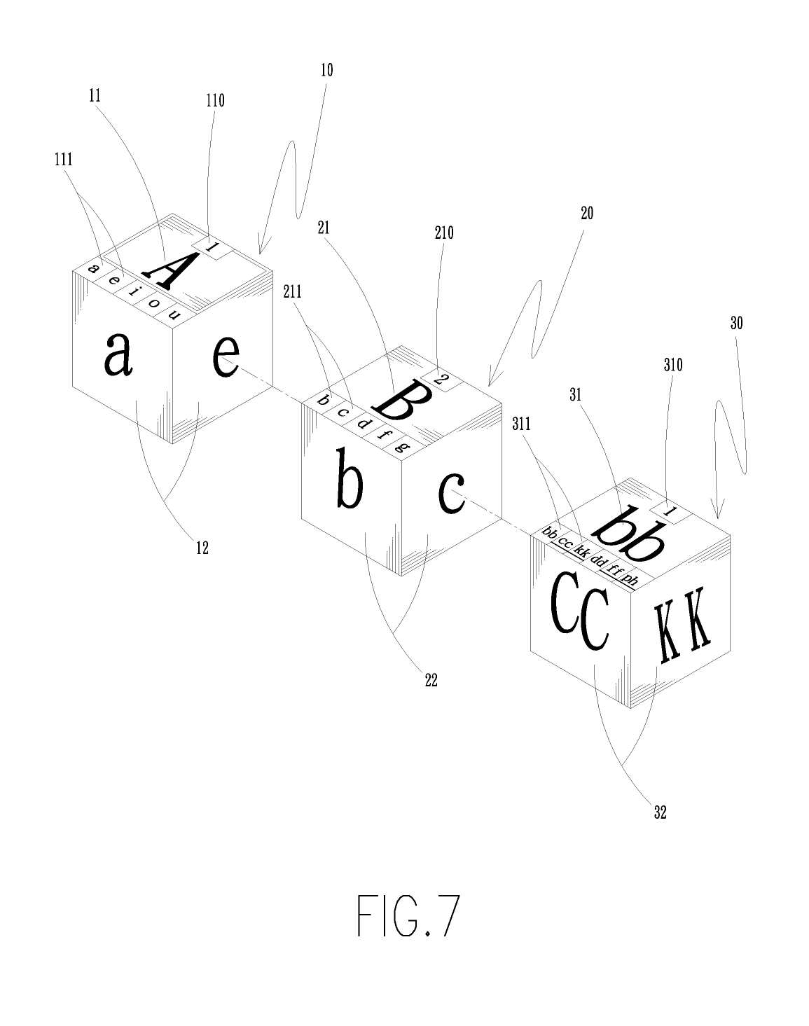

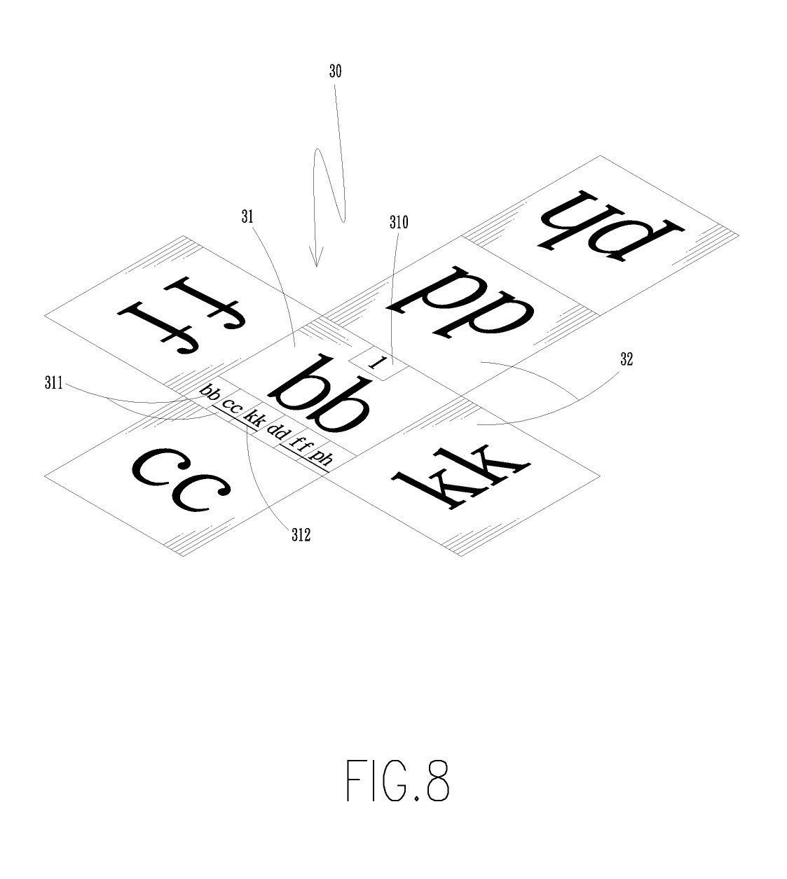

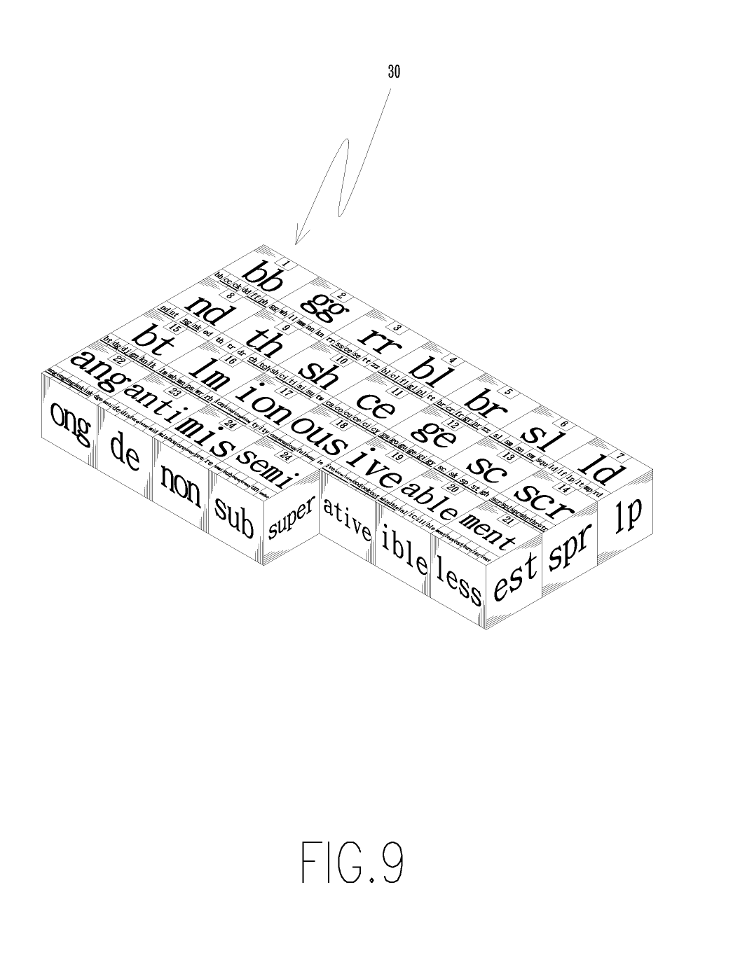

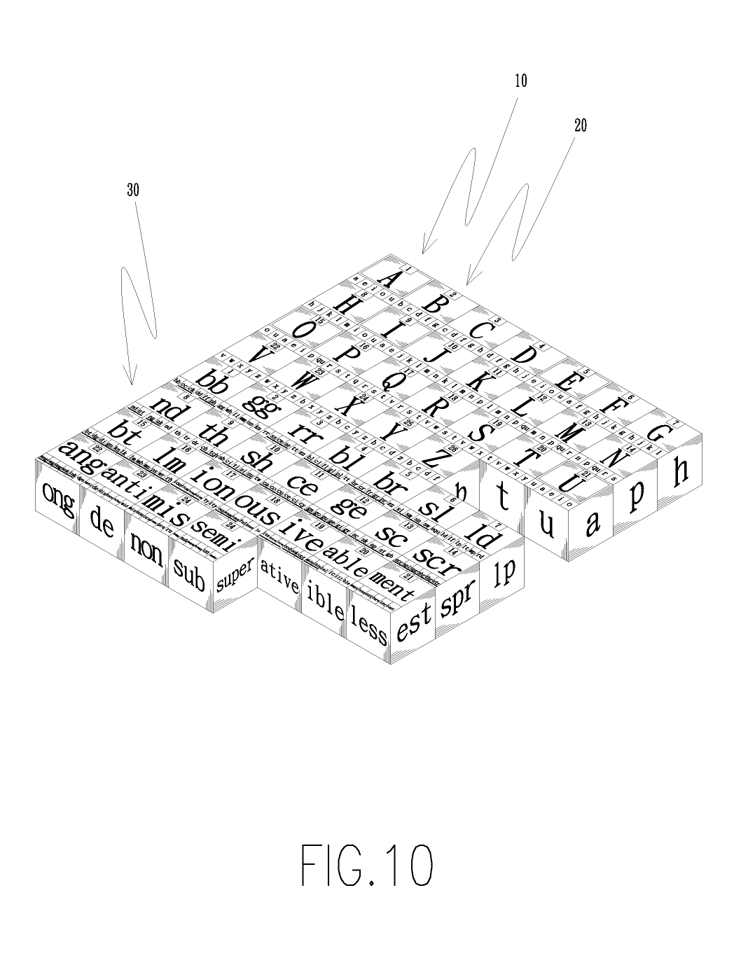

Referring to FIGS. 7 to 10, the teaching aid of a first preferred embodiment of the present invention further comprises a compound consonant cube. Wherein, a plurality of single vowel cubes 10 are disclosed, each of which includes a first main letter surface 11 and several vowel letter surfaces 12. The first main letter surface 11 provides with a first serial number 110 and a serial vowel area 111. Herein, the single vowel cube 10 is made of soft elastic foam or wood. Additionally, a plurality of single consonant cubes 20 are disclosed, each of which includes a second main letter surface 21 and several letter surfaces 22. The second main letter surface 21 provides with a second serial number 210 and a serial consonant area 211. Wherein, the second main letter surface 21 is able to connect with both the first main letter surface 11 and the several vowel letter surfaces 12 of the single vowel cube 10. Finally, a plurality of compound consonant cubes 30 are disclosed, each of which includes a main letter string surface 31 and several letter string surfaces 32. The main letter string surface 31 provides with a third serial number 310 and a serial letter string area 311. Wherein, the serial letter string area 311 includes first underlines 312 disposed under homogenous letter strings presented on the area 311 for an emphasis. The main letter string surface 31 and the several letter string surfaces 32 are able to connect with the first main letter surface 11 and the several vowel letter surfaces 12 of the single vowel cube 10 as well as connect with the second main letter surface 21 and the several letter surfaces 22 of the single consonant cube 20. Moreover, the compound consonant cube 30 is made of soft elastic foam or wood. By means of the above elements, the present invention provides with diverse utilizations.

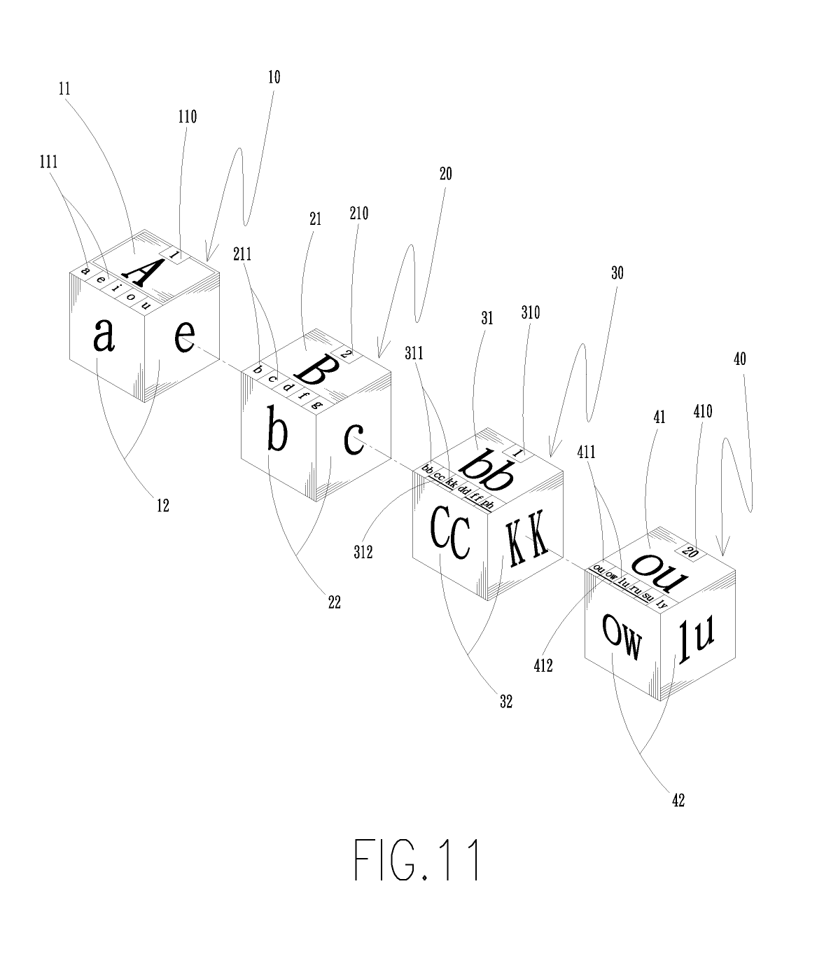

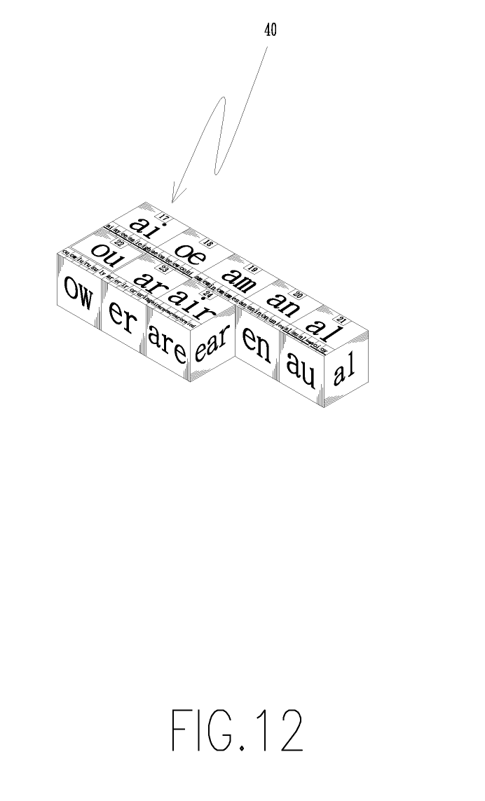

Referring to FIGS. 11 and 12, the teaching aid of a second preferred embodiment of the present invention further comprises a compound vowel cube. Wherein, a plurality of single vowel cubes 10 are disclosed, each of which includes a first main letter surface 11 and several vowel letter surfaces 12. The first main letter surface 11 provides with a first serial number 110 and a serial vowel area 111. Herein, the single vowel cube 10 is made of soft elastic foam or wood. Additionally, a plurality of single consonant cubes 20 are disclosed, each of which includes a second main letter surface 21 and several letter surfaces 22. The second main letter surface 21 provides with a second serial number 210 and a serial consonant area 211. Wherein, the second main letter surface 21 is able to connect with both the first main letter surface 11 and the several vowel letter surfaces 12 of the single vowel cube 10. As it should be, the single consonant cube 20 is also made of soft elastic foam or wood. Further, a plurality of compound consonant cubes 30 are disclosed, each of which includes a main letter string surface 31 and several letter string surfaces 32. The main letter string surface 31 provides with a third serial number 310 and a serial letter string area 311. Wherein, the serial letter string area 311 includes first underlines 312 disposed under homogenous letter strings presented on the area 311 for an emphasis. The main letter string surface 31 and the several letter string surfaces 32 are able to connect with the first main letter surface 11 and the several vowel letter surfaces 12 of the single vowel cube 10 as well as connect with the second main letter surface 21 and the several letter surfaces 22 of the single consonant cube 20. Moreover, the compound consonant cube 30 is made of soft elastic foam or wood. In addition, a plurality of compound vowel cubes 40 are disclosed, each of which includes a main compound vowel surface 41 and several compound vowel surfaces 42. The main compound vowel surface 41 provides with a fourth serial number 410 and a compound vowel area 411. The compound vowel area 411 includes second underlines 412 disposed under homogenous letter strings presented on the area 411 for an emphasis. The main compound vowel surface 41 and the several compound vowel surfaces 42 are able to connect with the first main letter surface 11 and the several vowel letter surface 12 of the single vowel cube 10, the second main letter surface 21 and the several letter surfaces 22 of the single consonant cube 20, as well as connect to the main letter string surface 31 and the several letter string surfaces 32 of the compound consonant cube 30. Wherein, the compound vowel cube 40 is also made of soft elastic foam or wood. By means of the above elements, the present invention provides with diverse utilizations.

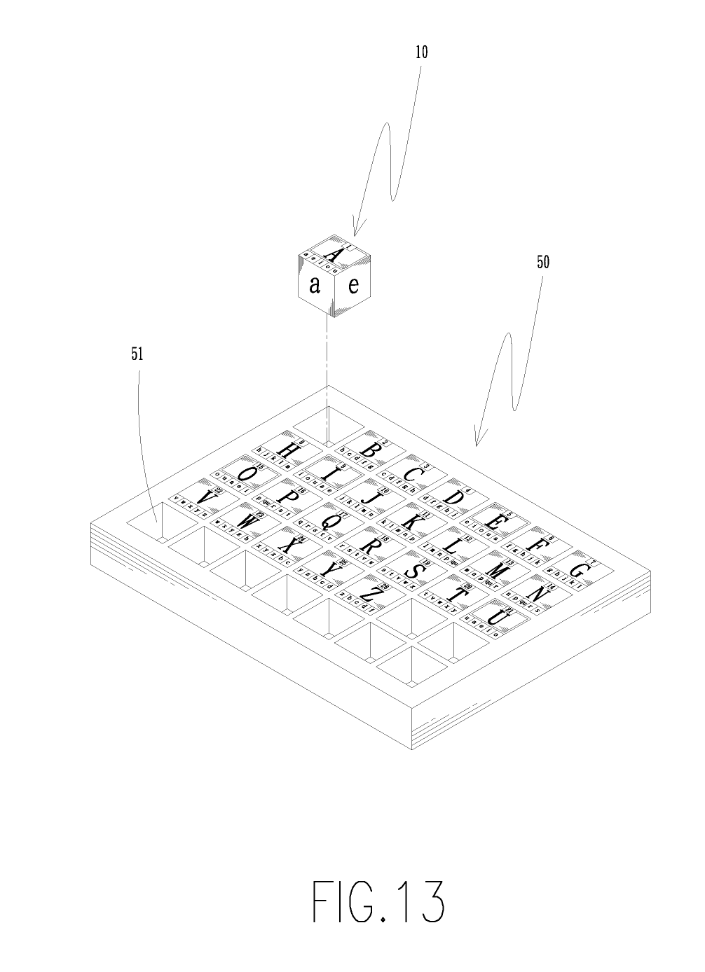

Referring to FIG. 13, the teaching aid of a third preferred embodiment of the present invention further comprises a frame body. In fact, the substantial structure in this embodiment is basically same to the embodiments shown from FIGS. 1 to 12. Particularly, the frame body 50 is disclosed. The frame body 50 includes a plurality of accommodating rooms 51. Whereby, the accommodating rooms 51 are served for containing the single vowel cubes 10, the single consonant cubes 20, the compound consonant cubes 30, and the compound vowel cubes 40. Preferably, the frame body 50 is also made of soft elastic foam or wood. By means of above elements, the teaching aid of the present invention is achieved, and the present invention

Thus, the present invention achieves the following advantages:
1. Convenient utilization: the single vowel cubes, the single consonant cubes, the compound vowel cubes and the compound consonant cubes provide preferable spelling practice for English vocabularies. As to the serial vowel area and the serial consonant area of the single vowel cube and the single consonant cube, users could explicitly turn them over for swiftly find letters. Moreover, as to the disposition of the serial numbers on the single vowel cube and the single consonant cube, users could sequentially locate the cubes with a speedy arrangement. Accordingly, the present invention achieves the convenient utilization.
2. Diverse function: by throwing or reversing one or several of the single vowel cubes and one or several of the single consonant cubes, the settled cubes with their vowel letter surface and the letter surface facing upward are able to provide users with a spelling and phonetic practice of English vocabularies. As a result, such teaching aid has a simple structure and low manufacturing cost. Moreover, since there are letters presented on each side of the cubes, the using variation could be more expanded. Accordingly, the present invention achieves the advantage of a diverse function.

Above description has shown the objects and substantial embodiments of the present invention, which indicate the present invention should be granted allowable, thereby application being filed.

I claim:

1. A phonics cubes for alphabetical spelling comprising:
a plurality of single vowel cubes, each of which including a first main letter surface and several vowel letter surfaces; said first main letter surface providing with a first serial number and a serial vowel area; and
a plurality of single consonant cubes, each of which including a second main letter surface and several letter surfaces; said second main letter surface providing with a second serial number and a serial consonant area; wherein, said second main letter surface being able to connect with both said first main letter surface and said several vowel letter surfaces of said single vowel cube.

2. The teaching aid as claimed in claim 1, wherein, said single vowel cubes and said single consonant cubes further cooperate with a frame body, in which a plurality of accommodating rooms are defined; said accommodating rooms are served for containing said single vowel cubes and said single consonant cubes.

3. A phonics cubes for alphabetical spelling comprising:
a plurality of single vowel cubes, each of which including a first main letter surface and several vowel letter surfaces; said first main letter surface providing with a first serial number and a serial vowel area;
a plurality of single consonant cubes, each of which including a second main letter surface and several letter surfaces; said second main letter surface providing with a second serial number and a serial consonant area; wherein, said second main letter surface being able to connect with both said first main letter surface and said several vowel letter surfaces of said single vowel cube; and
a plurality of compound consonant cubes, each of which including a main letter string surface and several letter string surfaces; said main letter string surface providing with a third serial number and a serial letter string area; said main letter string surface and said several letter string surfaces being able to connect with said first main letter surface and said several vowel letter surfaces of said single vowel cube as well as connect with said second main letter surface and said several letter surfaces of said single consonant cube.

4. The teaching aid as claimed in claim 3, wherein, said single vowel cubes, said single consonant cubes, and said compound consonant cubes further cooperate with a frame body, in which a plurality of accommodating rooms are defined; said accommodating rooms are served for containing said single vowel cubes, said single consonant cubes, and said compound consonant cubes.

5. The teaching aid as claimed in claim 3, wherein, said serial letter string area of said main letter string surface of said compound consonant cube includes underlines disposed under homogenous letter strings presented on the area for an emphasis.

6. A phonics cubes for alphabetical spelling comprising:
a plurality of single vowel cubes, each of which including a first main letter surface and several vowel letter surfaces; said first main letter surface providing with a first serial number and a serial vowel area;
a plurality of single consonant cubes, each of which including a second main letter surface and several letter surfaces; said second main letter surface providing with a second serial number and a serial consonant area; wherein, said second main letter surface being able to connect with both said first main letter surface and said several vowel letter surfaces of said single vowel cube;
a plurality of compound consonant cubes, each of which including a main letter string surface and several letter string surfaces; said main letter string surface providing with a third serial number and a serial letter string area; said main letter string surface and said several letter string surfaces being able to connect with said first main letter surface and said several vowel letter surfaces of said single vowel cube as well as connect with said second main letter surface and said several letter surfaces of said single consonant cube; and
a plurality of compound vowel cubes, each of which including a main compound vowel surface and several compound vowel surfaces; said main compound vowel surface providing with a fourth serial number and a compound vowel area; said main compound vowel surface and said several compound vowel surfaces being able to substantially connect with said first main letter surface and said several vowel letter surface of said single vowel cube, said second main letter surface and said several letter surfaces of said single consonant cube, as well as said main letter string surface and said several letter string surfaces of said compound consonant cube for multiple arrangements.

7. The teaching aid as claimed in claim 6, wherein, said single vowel cubes, said single consonant cubes, said compound consonant cubes, and said compound vowel cubes further cooperate with a frame body, in which a plurality of accommodating rooms are defined; said accommodating rooms are served for containing said single vowel cubes, said single consonant cubes, said compound consonant cubes, and said compound vowel cubes.

8. The teaching aid as claimed in claim 6, wherein, said compound vowel area of said main compound vowel surface of said compound vowel cube includes underlines disposed under homogenous vowel strings presented on the area for an emphasis.
